(19) United States
(12) Patent Application Publication
(10) Pub. No.: US 2011/0171490 A1
(43) Pub. Date: Jul. 14, 2011

(54) METHOD FOR THE PRODUCTION OF COMPOSITE METAL SEMI-FINISHED PRODUCTS

(75) Inventors: Cihangir Demirci, Krefeld (DE); Jutta Kloewer, Duesseldorf (DE)

(73) Assignee: ThyssenKrupp VDM GmbH, Werdohl (DE)

(21) Appl. No.: 12/998,089

(22) PCT Filed: Jul. 11, 2009
(86) PCT No.: PCT/DE2009/000973

§ 371 Date: Mar. 16, 2011

(30) Foreign Application Priority Data
Oct. 1, 2008 (DE) 10 2008 049 838.6
Jun. 17, 2009 (DE) 10 2009 025 197.9

(51) Int. Cl. B32B 15/01; C22B 4/00

(52) U.S. Cl. 428/656; 428/615; 75/10.23; 266/241; 428/686

(57) ABSTRACT

A method for producing composite metal semi-finished products wherein an electrode composed of a second metal or a second metal alloy is introduced into a main body designed as a crucible and composed of a first metal or a first metal alloy, and the electrode is fused off inside the main body while current is supplied, such that the first metal or the first metal alloy of the main body is melted over a defined cross-section, wherein the two metals or the two metal alloys after solidification thereof form a slag-free mixed zone composed of the two metals or the two metal alloys.

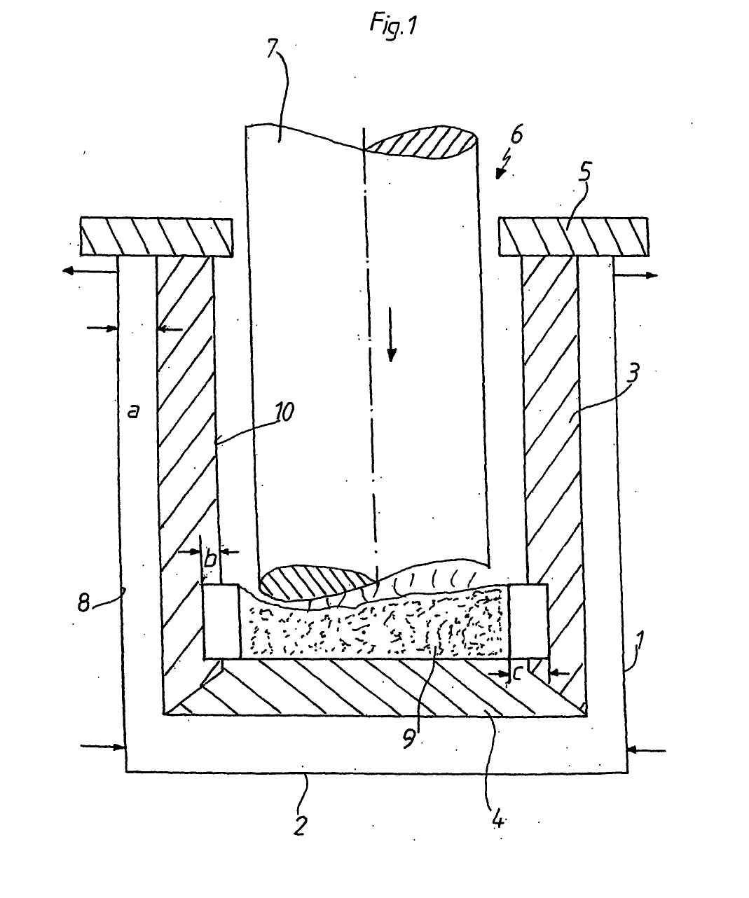

The invention relates to a semi-finished product as well as to a method for the production of composite metal semi-finished products.

DE 23 55 745 relates to a method for the production of composite metal pieces, primarily of roller bodies, having an outer skin and having a core of a different constitution or composition. According to this method, a first liquid metal is at first poured, in ascending manner, into a casting mold that has the shape of the piece to be produced. This metal is allowed to cool until a solidified outer skin having the desired thickness is achieved. The remaining liquid part of the first metal is drained off and it is simultaneously replaced by a second metal, having a different constitution and/or composition as compared with the first metal, which is supposed to form the core of the piece. In this connection, this second metal is introduced through the upper part of the casting mold.

In DE 25 53 402, a method and a device for the production of composite rollers are described, comprising a mantle of a first material having great hardness and wear resistance, and core and neck sections composed of a second material, which form the core of the roller. The mantle is pre-cast in the form of a hollow cylinder having a pre-determined outside diameter and a pre-determined thickness. A mold arrangement is set up, whereby the mantle sits on a mold section to form a neck of the roller, and the longitudinal axis of the mantle and of the mold section run in the vertical direction. Subsequently, an electrode composed of an electro-slag melt material is introduced into the interior of the mantle and of the neck mold section, which electrode is pre-manufactured from a material whose chemical composition is selected in such a manner that the core consists of the second material after melting and re-solidification of the core, and that the electrode is melted in such a manner that the interior of the mantle and of the mold section is filled. In this state of the art, the risk of slag formation between the inner and outer material exists, so that no connection of the two metals in the mixed region is possible.

WO 97/32112 discloses a turbine shaft, particularly for a steam turbine, which is directed along an axis of rotation and has an axially directed first region having a maximal radius, and an axially directed second region having a maximal radius R2>R1, whereby the first region has a first basic material for use at a first temperature, and the second region has a second basic material for use at a second temperature, which is lower in comparison with the first temperature, with a steel alloy, in each instance, containing 8.0 to 12.5 wt.-% chromium, with the austenitization temperature of the two alloys being essentially the same. Electrodes composed of the second material are melted off into the interior of a hollow cylinder, in accordance with the ESR method, so that here again, similar problems as described above are to be expected.

It is the goal of the object of the invention to make available a method for the production of composite metal semi-finished products, by means of which a plurality of different semi-finished products can be produced from different metals or metal alloys, for different cases of application.

Furthermore, a device for the production of composite metal semi-finished products is supposed to be proposed, which is simple in its structure and is suitable for the production of different composite metal semi-finished products from the most varied metals or metal alloys.

Finally, a composite metal semi-finished product is supposed to be presented, which has a good union of the two metals or metal alloys in a defined transition region.

This goal is achieved by means of a method for the production of composite metal semi-finished products, in that an electrode composed of a second metal or a second metal alloy is introduced into a basic body configured as a crucible, composed of a first metal or a first metal alloy, and the electrode is melted off within the basic body, with feed of current, in such a manner that the first metal or the first metal alloy of the basic body is melted off over a defined cross-section, whereby the two metals or the two metal alloys form a slag-free mixed zone composed of the two metals or the two metal alloys after their solidification.

Advantageous further developments of the method according to the invention can be derived from the related dependent method claims.

This goal is also achieved by means of a device for the production of composite metal semi-finished products, containing at least one cooling pot that has a bottom, which pot accommodates a basic body composed of a first metal or a first metal alloy, whereby the basic body is positioned at a defined distance from the wall of the cooling pot, and the basic body contains a bottom element, an electrode composed of a second metal or a second metal alloy, introduced within the basic body and melted off under VAR conditions, as well as a cooling medium that fills the free space between the basic body and the wall, whereby the basic body is closed off by means of a removable flange in the region of its upper end.

Advantageous further developments of the device according to the invention can be derived from the related dependent device claims.

This goal is also achieved by means of a composite metal semi-finished product composed of a first metal or a first metal alloy, an electrode composed of a second metal or a second metal alloy melted off within it, preferably under VAR conditions, whereby a slag-free mixed zone having a defined cross-section, composed of the two metals or the two metal alloys, exists between the two metals or the two metal alloys.

Advantageous further developments of the composite metal semi-finished product according to the invention can be derived from the related dependent product claims.

The cooling pot preferably consists of steel or a steel alloy.

A metal, for example a first nickel-based, iron-based, cobalt-based, or titanium-based alloy can be used as the material for the basic body configured as a crucible, while the electrode consists of a metal or a metal alloy, for example a second nickel-based, iron-based, cobalt-based, or titanium-based alloy. Depending on the later case of application, mixtures of first and second alloys can also be used.

The object of the invention is not restricted to the basic alloys mentioned; instead, as a function of the case of application, alternative, if necessary different metals or alloys can also be used. It is also possible to produce the crucible from a softer or harder material than the electrode. A person skilled in the art will select the suitable material as a function of the further processing and the demands on the end product, respectively.

It is particularly advantageous in the production of composite metal semi-finished products if the metals or metal alloys used have similar heat conductivity values. By means of this measure, it is possible to implement a particularly intimate, slag-free connection of the materials used, and a homogeneous mixed zone.

By means of the method according to the invention, and the device according to the invention, respectively, a composite metal semi-finished product is therefore formed, which contains a slag-free mixed zone composed of the two metals or the two metal alloys, in the region of a defined cross-section between the outer and the inner metal. By means of this measure, a slag-free, intimate connection between the two metals or metal alloys is brought about, which connection allows good further processing, for example by means of forging, whereby the advantages of the two metals or the two metal alloys are retained.

The composite metal semi-finished product produced by means of the method according to the invention can subsequently be re-shaped by means of suitable processing steps, such as extrusion, pilger rolling, rolling, forging, or drawing, to produce products such as wire, sheet, strip, or rods.

Table 1 reproduces some selected alloys that can be used for production of the composite metal semi-finished products according to the invention.

The object of the invention is shown in the drawing, using an exemplary embodiment, and will be described as follows.

The single FIGURE shows a device for the production of composite metal semi-finished products, as a schematic diagram.

A basic body 3 configured as a tubular component, composed of a first metal alloy, for example a nickel-based alloy, is introduced within a cooling pot 1 that consists of steel or a steel alloy, for example, and has a bottom 2 that is closed off in the downward direction. The tubular component 3 is closed off by means of a bottom element 4 in the region of its lower end. The bottom element 4 can be either welded to the component 3 or formed onto the component 3 in once piece. In its upper region, the component 3 is closed off by means of a removable flange 5, which (not shown here) stands in an active connection with the component 3, for example by means of a screw connection. The flange 5 has a recess 6 through which an electrode 7, composed of a second metal alloy, for example a different nickel-based alloy, is introduced. The component 3 is positioned at a defined distance a from the wall 8 of the cooling pot 1, whereby the free space is filled with a cooling medium, for example water, which flows through the cooling pot 1 from the bottom to the top. When the electrode 7 is melted off under VAR conditions, material 9 of the electrode 7 is melted off within the tubular component 3, rising from the bottom to the top. As a result of the metal alloys selected, for the tubular component 3, on the one hand, and the electrode 7, on the other hand, the interior wall 10 of the tubular component 3 is melted off over a cross-section b that can be pre-determined, so that in the solidified state of the composite metal semi-finished product, a slag-free mixed zone c composed of both metal alloys is present.

Merely as an example, it is stated that the crucible material alternatively consists of alloy 617, while the electrode can be formed from the same or a different material, such as alloy C-263, for example.

Both materials are nickel-based alloys, but they have different material properties. As has already been mentioned, the object of the invention is not restricted to nickel-based alloys, but rather other metals or alloys can also be used, as a function of the case of application of the end product.

In this connection, reference is made to Table 1, which contains further material combinations that have similar heat expansion coefficients for optimal slag-free formation of the mixed zone c.

### REFERENCE SYMBOL LIST

1 cooling pot
2 bottom
3 basic body (crucible)
4 bottom element
5 flange
6 recess
7 electrode
8 wall
9 material
10 interior wall basic body
a) distance basic body (3)-wall (8)
b) melted cross-section basic body (3)
c) mixed zone between electrode (7) and basic body (3)

TABLE 1
Heat conductivity values [W/mK]

| | Basic | | | | | | | | | |
|---|---|---|---|---|---|---|---|---|---|---|
| | body/ | | Basic body/ | | | | | | | |
| | crucible | Electrode | crucible | Electrode | Basic body/ | | Basic body/ | | Basic body/ | |
| Temp. | alloy 671 | C-263, | alloy 602 | C-263, | crucible | Electrode | crucible | Electrode | crucible | Electrode |
| (° C.) | (5520Co) | 5120CoTi | (6025H/HT) | 5120CoTi | Alloy 602 | Alloy 718 | Alloy 625 | Alloy 825 | Alloy X | Alloy 800 |
| 20 | 13.4 | 11.7 | 11.3 | 11.7 | 11.3 | 11.1 | 10.1 | 10.8 | 11.3 | 11.5 |
| 100 | 14.7 | 13 | 12.7 | 13 | 12.7 | 12.2 | 11.3 | 12.4 | 12.7 | 13.1 |
| 200 | 16.3 | 14.7 | 14.4 | 14.7 | 14.4 | 13.6 | 12.7 | 14.1 | 14.5 | 14.8 |
| 300 | 17.7 | 16.3 | 16 | 16.3 | 16 | 15.2 | 14.4 | 15.6 | 16.2 | 16.4 |
| 400 | 19.3 | 18 | 17.6 | 18 | 17.6 | 17 | 16 | 16.9 | 17.9 | 18.1 |
| 500 | 20.9 | 19.7 | 19.2 | 19.7 | 19.2 | 18.9 | 17.6 | 18.3 | 19.5 | 19.6 |
| 600 | 22.5 | 21.4 | 20.6 | 21.4 | 20.6 | 20.8 | 19.2 | 19.6 | 21.2 | 21.2 |
| 700 | 23.9 | 23 | 22.2 | 23 | 22.2 | 22.4 | 20.6 | 21 | 22.8 | 22.8 |
| 800 | 25.5 | 24.7 | 24.5 | 24.7 | 24.5 | 24.4 | 22.2 | 23.2 | 24.6 | 24.3 |
| 900 | 27.1 | 26.8 | 26.1 | 26.8 | 26.1 | 26.1 | 24.5 | 25.7 | 26.4 | 25.7 |
| 1000 | 28.7 | 28.5 | 27.7 | 28.5 | 27.7 | 28 | 26.1 | 28.1 | 28.2 | 27.3 |

| Temp. (° C.) | Alloy 200 | Alloy 400 |
|---|---|---|
| −200 | 78.5 | |
| −135 | | 22 |
| −100 | 75 | |
| −75 | | 24 |
| 0 | 71.5 | |
| 20/30 | 70.5 | 26 |
| 100 | 66.5 | 29.5 |
| 200 | 61.5 | 33 |
| 300 | 57 | 36.5 |
| 400 | 56 | 40 |
| 500 | 57.5 | 44 |
| 600 | 60 | 48.5 |
| 700 | 62 | 52 |
| 800 | 64 | 56 |
| 900 | 66.5 | 58 |
| 1000 | 69 | |

1. Method for the production of composite metal semi-finished products, wherein an electrode (7) composed of a second metal or a second metal alloy is introduced into a basic body (3) configured as a crucible, composed of a first metal or a first metal alloy, and the electrode (7) is melted off within the basic body (3), with feed of current, in such a manner that the first metal or the first metal alloy of the basic body (3) is melted off over a defined cross-section (b), whereby the two metals or the two metal alloys form a slag-free mixed zone (c) composed of the two metals or the two metal alloys after their solidification.

2. Method according to claim 1, wherein the basic body (3) is positioned at a defined distance (a) from the wall (8) of a cooling pot (1), and wherein the free space between the basic body (3) and the wall (8) has a cooling medium flowing through it.

3. Method according to claim 1, wherein the free space between the basic body (3) and the wall (8) is cooled with water.

4. Method according to claim 1, wherein the water flows through the free space between the basic body (3) and the wall (8) at a defined temperature and flow velocity, from bottom to top.

5. Method according to claim 1, wherein the electrode (7) is melted off within the basic body (3), under VAR conditions, in slag-free manner.

6. Method according to claim 1, wherein a hollow body, particularly a hollow cylinder, is used as the basic body (3), which is brought into an active connection with a bottom element (4) in the region of its lower end, and is closed off by means of a removable flange (5) in the region of its upper end.

7. Method according to claim 1, wherein a Ni-based, Fe-based, Co-based, or Ti-based alloy is used as the material for the hollow body (3).

8. Method according to claim 1, wherein a nickel-based, iron-based, cobalt-based, or titanium-based alloy is used as the electrode material (7).

9. Method according to claim 1, wherein the semi-finished product produced in this manner is re-shaped to produce wire, sheet, strip, or rod material.

10. Method according to claim 1, wherein the semi-finished product is converted to its final shape by means of extrusion, pilger rolling, rolling, forging, or drawing.

11. Device for the production of composite metal semi-finished products, containing at least one cooling pot (1) that has a bottom (2), which pot accommodates a basic body (3) composed of a first metal or a first metal alloy, whereby the basic body (3) is positioned at a defined distance (a) from the wall (8) of the cooling pot (1), and the basic body (3) contains a bottom element (4), an electrode (7) composed of a second metal or a second metal alloy, introduced within the basic body (3) and melted off under VAR conditions, as well as a cooling medium that fills the free space between the basic body (3) and the wall (8), whereby the basic body (3) is closed off by means of a removable flange (5) in the region of its upper end, wherein the flange (5) is connected with the basic body (3) by means of a screw connection, and the cooling medium is formed by water, which flows through the cooling pot (1) from the bottom to the top.

12-13. (canceled)

14. Composite metal semi-finished product, produced according to a method according to claim 1, consisting of a basic body (3) composed of a first metal or a first metal alloy, an electrode (7) composed of a second metal or a second metal alloy melted off within it under VAR conditions, whereby a slag-free mixed zone (c) having a defined cross-section, composed of the two metals or the two metal alloys, exists between the two metals or the two metal alloys, wherein the basic body (3), configured as a hollow body, consists of a different metal or a different metal alloy than the electrode (7).

15. (canceled)

16. Semi-finished product according to claim 14, wherein the hollow body (3) consists of a first Ni-based, Fe-based, Co-based, or Ti-based alloy.

17. Semi-finished product according to claim 14, wherein the electrode (7) consists of a second nickel-based, iron-based, cobalt-based, or titanium-based alloy.

18. Semi-finished product according to claim 14, wherein the hollow body (3) and the electrode (7) consist of alloys that have approximately the same type of heat expansion coefficients.
